(19) United States
(12) Patent Application Publication
(10) Pub. No.: US 2021/0245347 A1
(43) Pub. Date: Aug. 12, 2021

(54) Constant Velocity Axle Removal Tool

(71) Applicant: Dustin Robbins, Decatur, AL (US)

(72) Inventor: Dustin Robbins, Decatur, AL (US)

(21) Appl. No.: 17/173,921

(22) Filed: Feb. 11, 2021

Related U.S. Application Data
(60) Provisional application No. 62/975,384, filed on Feb. 12, 2020.

(51) Int. Cl. B25D 1/16; B25B 27/00

(52) U.S. Cl. CPC B25D 1/16; B25B 27/0035

(57) ABSTRACT

An axle removal tool is provided. The axle removal tool includes a tubular collar configured to encircle an axle. A plurality of threaded friction retainers is disposed on opposing sides of the interior of the tubular collar, which are configured to be tightened against the axle firmly securing the axle to the tubular collar. The tubular collar is operably connected to a pair of vertical supports. The vertical supports are connected to each other via a horizontal member. A first end of a shaft is operably connected to the horizontal member. A sliding hammer is slidably connected to the shaft. A striking surface is operably connected to a second end of the shaft. An individual can slide the sliding hammer along the shaft and strike the striking surface. In such a manner the axle, which is securely connected to the axle removal tool, is released from an automobile.

### CROSS REFERENCE TO RELATED APPLICATIONS

This application claims the benefit of U.S. Provisional Application No. 62/975,384 filed on Feb. 12, 2020. The above identified patent application is herein incorporated by reference in its entirety to provide continuity of disclosure.

### BACKGROUND OF THE INVENTION

The present invention relates to an automobile repair device. More specifically, the present invention provides an axle removal tool that comprises a sliding hammer that slides along a shaft to dislodge a Constant Velocity (“CV”) axle on an automobile.

In order for an individual to drive an automobile, the automobile must be able to transfer the combustion power that is produced from an engine to the automobile wheels. The combustion power that is produced from the engine is converted to momentum by the automobile's transmission. That momentum is transferred to the CV axle as a torque force. The torque allows the CV axle to rotate the wheels that move the automobile. While the automobile is moving, the CV axle accommodates for the vertical motion of suspension that the automobile experiences when the wheels are driven over different contours of the ground surface.

Over the life of the automobile, there can be high amount of wear that the CV axle experiences. When there is wear that occurs on the CV axle, the CV axle can become damaged or defective. Moreover, the high torque force and stress from the suspension motion that the CV axle experiences contributes to the wear that occurs over time. When the CV axles are damaged, it makes it difficult to properly operate the automobile. When the CV axles are completely broken and defective, the automobile is inoperable. The damage to the CV axle can appear inside the CV joint cup. The CV joint cup houses the CV joint bearings. If a CV axle is damaged or defective, the CV joint cup must be replaced with a new CV joint cup for the automobile to regain its proper function.

Removing the CV joint cup from the automobile can be a difficult process. Due to the position and orientation of the CV joint cup the person that is removing it can be in an inconvenient position. In such a position, getting the proper grasp of the axle to remove it is futile. Moreover, the CV joint cup can also be tightly secured within the transmission or the differential. When the CV joint cup is stuck to the transmission or differential, that will make it even more difficult for the individual to remove the CV joint cup from the automobile. Additionally, incorrectly removing the CV joint cup can cause damage to the automobile's transmission. If the transmission becomes damaged, then that can exacerbate the issue with removing the CV joint cup and greatly increasing the time and cost to repair the automobile.

Current methods for removing a damaged or broken CV axle require the individual performing the repair to use either a strong torque wrench or a socket wrench to loosen and remove the CV joint cup. However, due to the amount of grease or other lubricant that is on the CV joint cup for when it is in use, it can be difficult to have the wrench grasp the CV joint cup in order to properly remove the CV joint cup from the automobile. Additionally, the socket wrench may not have the appropriately sized socket to break loose the CV joint cup. Without the proper tools available to the individual attempting to remove a damaged CV axle, the chances increase that their attempt to repair leads to further damage to the automobile.

Therefore, there is a defined need amongst the known prior art references for an automotive repair tool that properly removes a damaged or broken CV joint cup from an automobile without causing further damage to the automobile's transmission or the differential.

### SUMMARY OF INF INVENTION

In view of the foregoing disadvantages inherent in the known types of axle removal tools now present in the known art, the present invention provides a new axle removal tool wherein a tubular collar is secured to the damaged or broken axle and a sliding hammer provides the axle removal tool the force necessary to dislodge the damaged or broken axle from an automobile.

It is therefore an object of the present invention to provide an axle removal tool that assists the user in removing a damaged or broken axle from an automobile without causing damage to other parts of the automobile. A plurality of threaded friction retainers secures a tubular collar to the axle's joint cup. The tubular collar is configured to have a diameter that can be positioned over and around an axle joint cup. When the tubular collar is in the correct position, the user can tighten the connection between the axle removal tool and the damaged or broken axle by tightening the plurality of threaded friction retainers. The plurality of threaded friction retainers is adjustable to accommodate for varying axles that are different in size depending on the type of automobile. On the ends of each threaded friction retainers there is a hexagonal bolt head that can allow the user to further tighten the threaded friction retainers connection by engaging a wrench, a screwdriver, or similar hardware tool to rotate the threaded friction retainers.

Another aspect of the present invention is a sliding hammer. The sliding hammer is slidably connected to a shaft. By way of a horizontal member and a pair of vertical supports, the shaft is connected to the tubular collar. The sliding hammer can move up and down the shaft from the horizontal member to a striking surface affixed to the end of the shaft. When the user is attempting to remove a damaged or broken axle, it can require a lot of force to properly dislodge the axle from the automobile without causing any further damage to the automobile's transmission or differential. When connected to the axle removal tool, use of the sliding hammer will create the necessary force to dislodge the damaged or broken axle from the automobile. The user will forcibly slide the sliding hammer along the shaft from the horizontal member to the striking surface. When the sliding hammer contacts the striking surface, the force created will dislodge the damaged or broken axle. Depending on the force applied by the user, it could take more than one slide of the sliding hammer to completely dislodge the axle.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of the axle removal tool.

FIG. 2 shows a side view of an embodiment of the axle removal tool.

FIG. 3 shows a bottom view of an embodiment of the axle removal tool.

FIG. 4 shows a perspective view of an embodiment of the axle removal tool in use.

### DETAILED DESCRIPTION OF THE INVENTION

Reference is made herein to the attached drawings. Like reference numerals are used throughout the drawings to depict like or similar elements of the axle removal tool. For the purposes of presenting a brief and clear description of the present invention, the preferred embodiment will be discussed is the axle removal tool with a sliding hammer. The figures are intended for representative purposes only and should not be limiting in any respect.

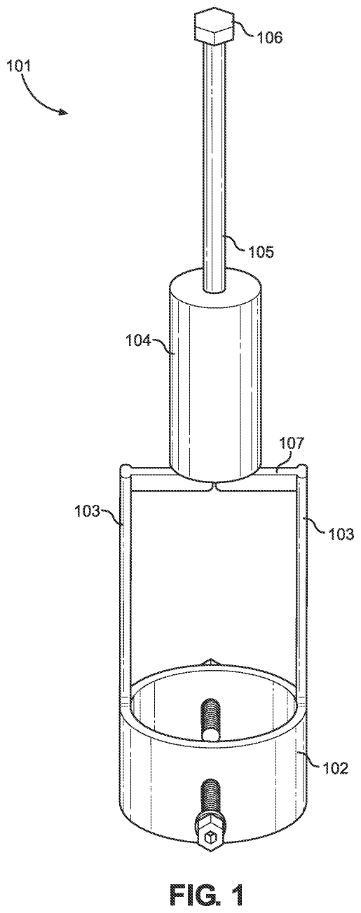

FIG. 1 shows a side view of an embodiment of an axle removal tool. The axle removal tool 101 comprises a tubular collar 102, a pair of vertical supports 103, a horizontal member 107, a shaft 105, and a sliding hammer 104. The tubular collar 102 is configured to encircle an axle. Specifically, the tubular collar 102 comprises a larger diameter than the axle such that the axle removal tool 101 can be positioned over and around an end of the axle. The tubular collar 102 has a top side, a bottom side, an interior face 301, and an external face.

Each vertical support 103 has two ends, a tubular collar end and a horizontal member end. The tubular collar end of the pair of vertical supports 103 are disposed on opposing ends of the top side of the tubular collar 102. The horizontal member 107 connect the pair of vertical supports 103. The horizontal member 107 is disposed on the horizontal member end of the pair of vertical supports 103.

The shaft 105 is perpendicularly disposed to the center of the horizontal member 107. The shaft 107 extends vertically from the horizontal member 107. The sliding hammer 104 comprises a cylindrical body with two opposing ends. A channel goes through the center of the cylindrical body from a first end of the cylindrical body to a second end of the cylindrical body of the sliding hammer 104. The sliding hammer 104 is slidably connected to the shaft 105. The shaft 105 goes through the channel by way of the two opposing ends so that the sliding hammer 104 can operably move up and down the shaft 105. A striking surface 106 is operably connected to the end of the shaft 105 opposite from the horizontal member 107. The axel removal tool 101 is configured such that a user can slide the sliding hammer 104 along the shaft 105 and strike the striking surface 106. The striking surface 106 is configured to prevent the sliding hammer 104 from being detached from the shaft 105.

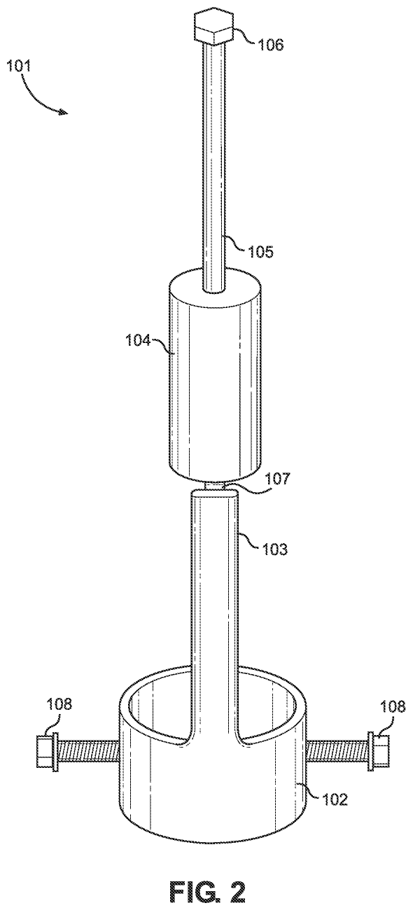

FIG. 2 shows a side view of an embodiment, of an axle removal tool. The axle removal tool 101 further comprise a plurality of threaded friction retainers 108. The plurality of threaded friction retainers 108 is inserted through the external face and the internal face 301 of the tubular collar 102. In this embodiment of the axle removal tool 101, the plurality of threaded friction retainers 108 is disposed on opposing sides of the tubular collar 102.

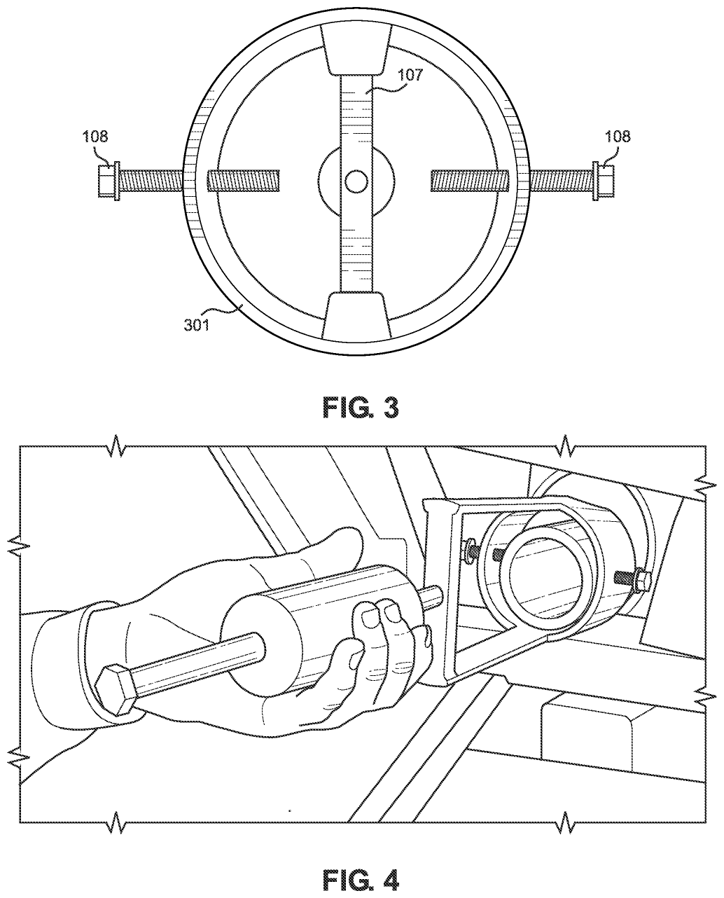

FIG. 3 shows a bottom view of an embodiment of an axle removal tool. Automobiles can have axles that are different sizes than axles on other types of automobiles. To properly remove an axle that is defected or broken, there needs to be a tight connection between the axle and the tool that is assisting an individual to remove the axle. The tool being used must accommodate for axles of varying sizes in order to form the tight connection. For this embodiment of the axle removal tool 101, the plurality of threaded friction retainers 108 can be adjusted to secure the axle to the internal face BOX of the tubular collar 102. Each threaded friction retainer 108 can rotated about the tubular collar 102 to accommodate for varying axle sizes. The plurality of threaded faction retainers 108 can be inserted further into the tubular collar 102 or retracted from the tubular collar 102. In this embodiment of the plurality of threaded friction retainers 108, a hexagonal bolt head can be used to firmly tighten the plurality of threaded friction retainers 108 around the end of the axle.

FIG. 4 shows a perspective view of an embodiment of the axle removal tool in use. In use, tubular collar 102 encircles the damaged or broken axle joint cup. The user will rotate the plurality of threaded friction retainers 108 to form a tight connection around the damaged or broken axle joint cup. If necessary, the user can further tighten the connection by engaging a wrench, a screwdriver, or similar hardware tool with the hexagonal bolt head on the end of each threaded friction retainers 108. When the axle removal tool 101 is tightly secured to the damaged or broken axle joint cup, the user will grip the sliding hammer 104 and forcibly slide it along the shaft 105 from the horizontal member 107 to the striking surface 106. The user will continue to slide the sliding hammer 104 along the shaft 105 until the damaged or broken axle joint cup is extracted from the automobile. When the damage or broken axle joint cup is removed from the automobile, the user can loosen the connection from the plurality of threaded friction retainers 108 to dislodge the damaged or broken axle from the axle removal tool 101.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention

1. An automobile tool, comprising:
a tubular collar;
the tubular collar further comprises an interior face, an exterior face, a top side, and a bottom side;
a plurality of threaded friction retainers;
wherein the plurality of threaded friction retainers is operably connected to the tubular collar;
a pair of vertical supports disposed on the top side of the tubular collar;
a horizontal member connected to the pair of the vertical supports;
a shaft operably connected to the top of the horizontal member;
a striking surface is disposed on the end of the shaft; and
a sliding hammer slidably connected to the shaft.

2. The automobile tool of claim 1, wherein the tubular collar is configured to have a diameter that can be positioned over and around an end of an axle.

3. The automobile tool of claim 1, wherein the plurality of threaded friction retainers is inserted through the external face and the interior face of the tubular collar.

4. The automobile tool of claim 1, wherein the plurality of threaded friction retainers is disposed on opposing sided of the tubular collar.

5. The automobile tool of claim 1, wherein the plurality of threaded friction retainers is rotated about the tubular collar to tighten the connection of the tubular collar to the end of an axle.

6. The automobile tool of claim 1, wherein the sliding hammer slides along the shaft from the horizontal member to the striking surface.
